(19) United States
(12) Patent Application Publication
(10) Pub. No.: US 2012/0100308 A1
(43) Pub. Date: Apr. 26, 2012

(54) TERNARY METAL ALLOYS WITH TUNABLE STOICHIOMETRIES

(75) Inventors: Robert B. Milligan, Gold Canyon, AZ (US); Dong Li, Pheonix, AZ (US); Steven Marcus, Tempe, AZ (US)

(73) Assignee: ASM America, Inc., Phoenix, AZ (US)

(21) Appl. No.: 12/911,585

(22) Filed: Oct. 25, 2010

(51) Int. Cl. H05H 1/42; B05C 11/00

(52) U.S. Cl. 427/569; 118/706

(57) ABSTRACT

Methods and equipment for forming ternary metal alloys are provided. In some embodiments, TaCN thin films are deposited by exposing a substrate to alternating pulses of an organometallic tantalum precursor comprising nitrogen and carbon and hydrogen plasma. The stoichiometry of the film is tuned from carbon rich to nitrogen rich by adjusting the plasma parameters, particularly the plasma power and duration. In this way, films with varied characteristics can be formed from the same precursor. For example, both n-type and p-type materials can be deposited in the same module using the same precursor.

### BACKGROUND OF THE INVENTION

1. Field of the Invention

The present invention relates generally to vapor deposition processes and, more particularly, to deposition of ternary metal alloys, such as TaCN films, by vapor deposition processes.

2. Description of the Related Art

The integration level of components in integrated circuits is constantly increasing, which demands a decrease in the sizes of integrated circuit (IC) components and interconnects. The trend of decreasing feature size is evident, for example, in memory circuits or devices such as dynamic random access memories (DRAMs), flash memory, static random access memories (SRAMs), ferroelectric (FE) memories, and integrated circuit components, such as gate electrodes and diffusion barriers in complementary metal oxide semiconductor (CMOS) devices.

Refractory metal-nitrides and metal carbides have been identified by integrated circuit manufacturers as desirable materials for gate metals in CMOS devices and flash memory devices. Previously, doped polysilicon has been employed as a gate metal. However, as design rules become progressively smaller and more advanced, it is becoming common to use different gate materials for the p-mos and the n-mos transistors. Advanced designs now call for separate materials for the n-mos and p-mos gates with workfunctions that are tuned to each device.

Tantalum carbide (TaC), tantalum nitride (TaN) and tantalum carbide-nitride (TaCN) have been identified as potential p-type and n-type gate materials. Thin films of these materials have been formed by various methods, including chemical vapor deposition (CVD), physical vapor deposition (PVD) and atomic layer deposition (ALD), sometimes also referred to as atomic layer epitaxy (ALE). Some methods for depositing these materials use a tantalum precursor which does not contain carbon or nitrogen, such as TaCl₅, in combination with a carbon bearing and/or nitrogen bearing second reactant. In other methods, an organometallic tantalum precursor is used which contains both nitrogen and carbon, in combination with a hydrogen plasma to reduce and deposit the desired material.

### SUMMARY OF THE INVENTION

TaCN films can be deposited by plasma enhanced atomic layer deposition from organometallic tantalum precursors comprising tantalum, nitrogen and carbon. By adjusting one or more of the reaction conditions, such as the plasma intensity, the stoichiometry of the TaCN film can be tuned from carbon rich to nitrogen rich. In this way, both n-type and p-type materials can be deposited from the same precursor using a common methodology.

In some embodiments of the invention, methods for depositing TaCN thin films by plasma enhanced atomic layer deposition (PEALD) type processes are provided. A substrate in a reaction space is alternately and sequentially exposed to pulses of a metal organic precursor comprising tantalum, nitrogen and carbon and a plasma-excited species, such as hydrogen plasma. In some embodiments the metal precursor is tertbutylimide-tridiethylamide-tantalum (TBTDET). Reaction conditions, such as plasma power, plasma duration, temperature and pressure are adjusted to achieve deposition of a thin film with a desired composition.

In some embodiments, methods for forming an integrated circuit are provided. The methods comprise a first deposition cycle depositing a first metal carbide film comprising: alternatingly exposing a substrate to pulses of a transition metal precursor and a plasma-excited hydrogen species, the metal precursor selected from the group consisting of transition metal halides and transition metal organic compounds; and reacting metal from the metal precursor with a carbon species to form the first metal carbide film on the substrate, wherein the plasma parameters are selected to produce a first metal carbide film with a desired workfunction. The methods further comprise a second deposition cycle depositing a second metal carbide film, wherein the precursors in the second deposition cycle are the same as the precursors in the first deposition cycle. The reaction conditions in the second deposition cycle are different from the first deposition cycle and are selected to produce a second metal carbide film with a workfunction different from the first metal carbide film.

In some embodiments, methods are provided for forming an integrated circuit. The methods comprise exposing a substrate to metal and carbon-containing reactants to deposit a first film comprising the metal and carbon; exposing the first film comprising metal and carbon to a plasma-excited hydrogen species to form a first metal carbide film having a first composition; forming a second film comprising metal and carbon by exposing a substrate to metal and carbon-containing reactants; and exposing the second film comprising metal and carbon to a plasma-excited hydrogen species to form a second metal carbide film having a second composition, wherein the second composition is different from the first composition, wherein the same reactants are used to form the first and second films.

In some embodiments, a system for depositing metal carbide films is provided. The system comprises a reaction chamber; a plasma generator; a metal precursor source in gas communication with the reaction chamber; a carbon precursor source in gas communication with the reaction chamber; a hydrogen source in gas communication with the reaction chamber; and a controller programmed to perform a first metal carbide cycle comprising providing a plurality of pulses of the metal precursor and the carbon precursor to the reaction chamber and to separately provide pulses of a hydrogen plasma into the reaction chamber between the pulses of the metal precursor and the carbon precursor; and the controller further programmed to perform a second metal carbide cycle comprising alternately provide pulses of additional metal precursor and pulses of hydrogen plasma to the reaction chamber in a cycle with the plurality of pulses of the metal precursor and the carbon precursor and the separately provided pulses of hydrogen plasma.

### BRIEF DESCRIPTION OF THE DRAWINGS

The invention will be better understood from the Detailed Description and from the appended drawings, which are meant to illustrate and not to limit the invention.

FIG. 1 is a block diagram of a pulsing sequence in a deposition process according to some embodiments of the invention.

FIG. 2 is a block diagram of a pulsing sequence in a deposition process according to some embodiments of the invention.

FIG. 3 illustrates a reactor configured to form films in accordance with one embodiment of the invention.

FIG. 4 is a graph illustrating the lattice constant versus plasma on-time for TaCN thin films deposited in accordance with various embodiments with a plasma power of 225 W and 275 W.

FIG. 5 is a graph illustrating the lattice constant and resistivity versus plasma tuning for TaCN thin films deposited in accordance with various embodiments.

FIG. 6 is a graph illustrating the lattice constant versus plasma power for TaCN thin films deposited in accordance with various embodiments.

### DETAILED DESCRIPTION OF SOME EMBODIMENTS

Embodiments of the invention advantageously allow for tuning the stoichiometry of ternary metal carbon-nitrogen alloys, such as TaCN films. A substrate is exposed to pulses of reactants (also referred to as precursors) in a plasma enhanced atomic layer deposition (PEALD) process. In some embodiments, a substrate in a reaction space is alternately and sequentially exposed to an organometallic precursor and a plasma-excited reactant, typically hydrogen plasma. The organometallic precursor adsorbs on the substrate surface in a self-limiting manner to form at most a monolayer of reactant. In some embodiments conditions can be adjusted such that less than a monolayer of reactant can be adsorbed on the surface of the substrate. In some embodiments conditions can be adjusted such that more than a monolayer of reactant can be adsorbed on the surface of the substrate. The hydrogen plasma reacts with the organometallic precursor to form a metal carbide-nitride. In particular, the plasma-excited hydrogen can facilitate the formation of the metal carbide-nitride by separating hydrocarbons from the metals to which the hydrocarbons are attached as organic ligands. The hydrogen plasma can also aid in removal of undesired chemical species, such as oxygen atoms, to form a film having low levels of impurities.

The stoichiometry, and hence the composition of the films, is determined in part by the plasma parameters during film deposition. By selecting particular plasma parameters during film deposition, metal carbide-nitride films may be formed with compositions as desired. For example, one set of plasma parameters can be used to deposit a nitrogen rich TaCN film. The plasma parameters can then be changed and a carbon rich TaCN film can be deposited using the same precursors in the same reaction chamber. In this way, both n-type and p-type materials can be deposited from a single precursor using a common process. This obviates the need for additional hardware and additional precursors, thus reducing the complexity of hardware and costs. In addition, undesirable precursor cross-contamination that can occur when switching precursors to deposit different materials is avoided.

By tuning the composition of the metal carbide-nitride films, the workfunction and other material properties, including, but not limited to, resistivity, stress, lattice constant and crystallinity, can be tuned along a stoichiometric continuum to match device specifications.

Although described herein primarily in terms of deposition of tantalum carbide-nitride (TaCN) for use as p-type and n-type materials in CMOS devices, the skilled artisan will appreciate that the disclosed methods can readily be adapted for use in a variety of other contexts and for deposition of a variety of alloys, such as ternary metal alloys. For example, other alloys that can be deposited with the disclosed methods include WCN, NbCN, ZrCN, and TiCN and combinations thereof.

### DEFINITIONS

In the context of the present description, an “ALD process” or “ALD type process” generally refers to a process for producing films or thin films over a substrate in which the film is formed atomic or molecular monolayer-by-monolayer (ML) due to self-saturating chemical reactions. The general principles of ALD are disclosed, e.g., in U.S. Pat. Nos. 4,058,430 and 5,711,811, the disclosures of which are incorporated herein by reference. In an ALD process, gaseous reactants, i.e., precursors or source materials, are alternately and sequentially conducted into a reaction space of an ALD reactor where they contact a substrate located in the chamber to provide a surface reaction. Consequently, typically only up to one monolayer (i.e., an atomic layer or a molecular layer) of material is deposited at a time during each temporally and spatially-separated pulsing cycle. Gas phase reactions between precursors and any undesired reactions of by-products are inhibited because precursor pulses are separated from each other by time and the reaction chamber is evacuated using a purge gas (e.g., nitrogen, argon, and/or hydrogen) and/or a pumping system between precursor pulses to remove surplus gaseous reactants and reaction by-products from the chamber. Thus, the concentration profiles of the reactants in the reaction space with respect to time are not overlapping. However, the skilled artisan will recognize that more than one monolayer may be deposited in one or more ALD cycles despite the separation of reactant pulses.

“Plasma-excited species” refers to radicals, ions or other excited species generated via application of energy to a gas. Plasma-excited species may be generated using a direct plasma generator (i.e., “in situ” or “direct” plasma generation) and/or a remote plasma generator (i.e., “ex situ” or “remote” plasma generation). Energy may be applied (or coupled) to a gas via a variety of methods, such as inductive coupling, ultraviolet radiation, microwaves, capacitive coupling, application of RF power, etc. In the absence of coupling energy, plasma generation is terminated. Plasma-excited species include, without limitation, hydrogen radicals.

“Plasma parameters” is used to designate one or more plasma generation variables, including, without limitation, plasma generator power, gas pressure, gas (or reactant) flow rate, and plasma pulse duration, also referred to as plasma “on time.” As an example, for plasma generation using RF power, plasma parameters include, without limitation, radio frequency (RF) power on time, RF power amplitude, RF power frequency or frequencies (for dual frequency systems), reactant concentration, reactant flow rate, reaction space pressure, total gas flow rate, reactant pulse durations and separations, and RF electrode spacing.

A “PEALD process” refers to a process for producing films or thin films over a substrate in which a thin film is formed primarily monolayer by monolayer due to self-saturating chemical reactions, such as adsorption of a source chemical (e.g., metal source chemical) and reaction between adsorbed species and plasma-excited species. In a PEALD process the reactants are separated per ALD. The PEALD process uses plasma for one or more reactants.

“Reaction space” is used to designate a reactor or reaction chamber (“chamber”), or an arbitrarily defined volume therein, in which conditions can be adjusted to effect thin film growth. Typically the reaction space includes surfaces subject to all reaction gas pulses from which gases or particles can flow to the substrate, by entrained flow or diffusion, during normal operation. The reaction space can be, for example, in a single-wafer plasma enhanced ALD (PEALD) reactor or a batch PEALD reactor, where deposition on multiple substrates takes place at the same time. PEALD reactors include, without limitation, EmerALD™ and Pulsar™ reactors available commercially from ASM America, Inc. of Phoenix, Ariz.

“Substrate” can include any workpiece that is suitable for deposition by PEALD. Typical substrates include, without limitation, semiconductors (e.g., silicon wafers) and insulators (e.g., glass substrates). “Substrate” is meant to encompass bare substrates as well as partially fabricated substrates with layers and patterns formed thereon, including one or more layers formed in prior ALD cycles.

“Surface” is used to designate a boundary between the reaction space and a feature of the substrate.

“Thin film” refers to a film that is grown from elements or compounds that are transported as separate ions, atoms or molecules via vacuum, gaseous phase or liquid phase from the source to the substrate. The thickness of the thin film depends upon the application and may vary in a wide range, preferably from one molecular layer to 30 nanometers (nm).

### Film Composition as a Function of Plasma Parameters

According to preferred embodiments, metal carbide nitride films, such as TaCN, are formed by plasma enhanced atomic layer deposition (PEALD) processes. Preferred methods include selecting plasma parameters to deposit a film or thin film of desired composition. Plasma parameters can be established from relationships between plasma parameter(s) and film composition. That is, film composition is controlled as a function of plasma parameters. In addition to composition, other film characteristics such as crystallinity, crystal lattice constant, resistivity and crystal stress can be adjusted by selecting appropriate plasma parameters.

According to preferred embodiments, plasma parameters are selected from relationships that have been established between plasma parameters and film composition and characteristics. “Plasma parameters” may include one plasma parameter, such as RF power, or multiple plasma parameters, i.e., a set of plasma parameters, such as RF power, RF frequency, and RF pulse on-time. Plasma parameters are selected to yield a metal carbide-nitride film with composition as desired. In preferred embodiments, plasma parameters are selected to yield a metal-rich metallic-compound film. In some cases plasma parameters are selected to form a gate electrode with a particular composition to yield a desired gate stack work function.

In preferred embodiments, deposition recipes for metal carbide-nitride films are determined or designed by selecting plasma parameters. As an example, the RF power may be selected to effect a stoichiometry as desired. As another example, the desired composition may be achieved by selecting a particular plasma pulse duration or RF power on time. As still another example, the desired composition may be achieved by selecting a combination of RF power, reactant pulse duration and reactant flow rate.

Relationships between plasma parameters and thin film composition can be established by selecting plasma parameter(s) and depositing a metallic carbide-nitride film by a plasma-enhanced atomic layer deposition (PEALD) process using the selected plasma parameter(s) until a film of desired thickness is formed. The film composition and characteristics can then be determined and another film deposited using a different plasma parameter (or parameters). This process can be repeated for different values of the plasma parameter(s) to develop relationships between the plasma parameter(s) and film composition.

Generally, higher plasma intensity leads to carbon rich TaCN and lower intensity to nitrogen rich TaCN. Increasing the plasma intensity, for example increasing the RF power or RF pulse on-time, deposited carbon rich tantalum films. Decreasing the plasma intensity, for example increasing the RF power or RF pulse on-time, deposited nitrogen rich tantalum films. Plasma intensity can be controlled, for example, by modifying RF power, RF pulse-on time, or some combination of both. Other reaction conditions such as temperature and pressure can also be selected to deposit a tantalum film having a desired composition. An RF plasma generator was used to generate plasma-excited species.

### Preferred ALD Methods

According to some preferred embodiments, a PEALD type process is used to form metal carbide-nitride thin films, particularly low-resistivity tantalum carbide-nitride thin films, on substrates, such as integrated circuit workpieces. According to preferred methods, a metal carbide-nitride film is deposited with a predetermined composition by selecting appropriate plasma parameters in a plasma-enhanced atomic layer (PEALD) process. As discussed above, this may include, e.g., selecting RF power, duration of plasma, plasma frequency, and/or ratio of gas flow rates.

PEALD methods described herein can be employed, for example, to form p-type and n-type gate metals in CMOS devices, or any metal carbide-nitride film where control of metal carbide-nitride film characteristics is desirable. In forming gate stacks, plasma parameters can be selected to form gate electrodes of desired composition, which will in turn dictate the gate stack work function.

The process for the formation of controlled-composition compound films preferably comprises an atomic layer deposition type process, including an alternating and repeated exposure of the substrate to spatially and temporally separated vapor phase pulses of at least two reactants, so that a compound film of at least binary composition is formed. In preferred embodiments, the at least two reactants comprises a metal source chemical (or precursor of a metal) and a plasma-excited species. In some embodiments, the at least two reactants may include a third reactant comprising a species incorporated into the film.

According to preferred embodiments of the invention, metal carbide-nitride films are deposited in a “two-step” process in which a substrate in a reaction space is contacted with alternating and sequential pulses of a first reactant comprising metal, carbon and nitrogen and a plasma activated second reactant. In accordance with ALD principles, reactant pulses are separated spatially and temporally, such as by purge steps.

A substrate or workpiece placed in a reaction chamber is subjected to alternately repeated surface reactions. In particular, thin films are formed by repetition of an ALD cycle. Preferably, each ALD cycle comprises at least two distinct phases. One reactant will adsorb no more than about one monolayer on the substrate surface under the reaction conditions and includes a metal species desired in the layer being deposited. A preferred metal is tantalum. This reactant, also referred to herein as “the metal reactant,” is preferably an organometallic reactant comprising metal, carbon and nitrogen. In some embodiments, the metal reactant has a formula comprising:

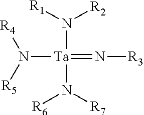

wherein each R₁, R₂, R₃, R₄, R₅, and R₆ is independently selected from:
i. hydrogen;
ii. linear and branched C₁-C₂₀ alkyl, alkenyl and alkynyl groups, which are independently substituted or unsubstituted;
iii. carbocyclic groups, such as aryl, preferably phenyl, cyclopentadienyl, alkylaryl, and halogenated carbocyclic groups; and
iv. heterocyclic groups.

In preferred embodiments the metal reactant is tertbutylimide-tridiethylamide-tantalum (TBTDET). In some embodiments, the metal reactant is TAIMATA (ethyldimethylamide-trimethylamide-tantalum; Ta(NMe₂)₃(NCMe₂Et)). The second reactant is preferably hydrogen plasma.

Additional reactants may also be included in the process and may, for example, contribute one or more species to the growing film. Additional reactants may be provided in each deposition cycle, or at intervals in the deposition process, for example every second, third, fourth, fifth, etc. . . . deposition cycle.

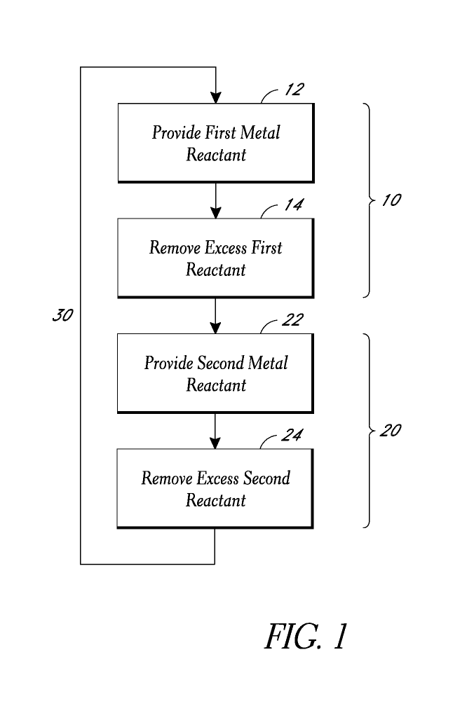

A preferred ALD cycle for depositing a metal carbonitride is illustrated in FIG. 1. In one phase of the ALD cycle (“the metal phase” or the “first phase”) 10, a first reactant comprising a metal species, carbon and nitrogen (the “metal reactant”) is supplied in a first pulse 12 to the reaction chamber and chemisorbs to the substrate surface. The reactant supplied in this phase 10 is selected such that, under the reaction conditions, the amount of reactant that can be bound to the surface is determined by the number of available binding sites and by the physical size of the chemisorbed species (including ligands). The chemisorbed layer left by a pulse of the metal reactant is self-terminated with a surface that is non-reactive with the remaining chemistry of that pulse. This phenomenon is referred to herein as “self-saturation.” One of skill in the art will recognize that the self-limiting nature of this phase makes the entire ALD cycle self-limiting.

Maximum step coverage on the workpiece surface is obtained when no more than about a single molecular layer of metal source chemical molecules is chemisorbed in each self-limiting pulse. Due to the size of the chemisorbed species and the number of reactive sites, somewhat less than a monolayer may be deposited in each pulse of metal reactant.

In the next phase of the cycle (the “second phase”) 20, a pulse 22 of a second plasma reactant is allowed to react with the molecules left on the substrate surface by the preceding pulse, if any. In the illustrated embodiment, in the phase 20 following chemisorption of the metal reactant, hydrogen plasma is supplied to the reaction chamber. This phase 20 is referred to herein as “the second phase” or the “plasma phase.” In the preferred embodiment the metal reactant is TBTDET and its reaction with hydrogen plasma produces a TaCN layer on the substrate.

In step 22, the substrate is exposed to a second reactant pulse. In some embodiments the second reactant comprises hydrogen plasma. The step 22 is temporally separated from the step 12. “Hydrogen plasma” is used to designate one or more excited hydrogen species formed via application of energy to a gas comprising hydrogen. Energy may be applied (or coupled) to the gas via any of a variety of methods, such as inductive coupling, ultraviolet radiation, microwaves, capacitive coupling, application of RF power, etc. In the absence of coupling energy, plasma generation is terminated. Thus, the pulse 22 can be provided by constantly flowing hydrogen during the deposition cycle and then pulsing the coupling energy to generate a pulse of plasma-excited hydrogen species. In some embodiments, plasma is generated directly within the reaction chamber. Alternatively, plasma can be generated remotely, upstream of the reaction chamber, in a remote plasma generator. In some embodiments, the plasma can be accompanied by a carrier gas such as argon, nitrogen, or other inert gas.

The present invention advantageously enables metal carbide film formation by employing plasma-excited hydrogen species, which, without being limited by theory, are believed to provide sufficient energy to promote formation of the metal carbide-nitride at lower temperatures, e.g., about 500° C. or less, or about 400° C. or less. Plasma production generates radicals of the hydrogen. Because radicals have substantially short lifetimes, metal carbide-nitride formation occurs primarily at locations where the substrate or workpiece in the reaction space is in view of the plasma-excited hydrogen. As such, metal carbide-nitride films can be formed in a controlled manner, and undesirable consequences of plasma usage, such as electrical shorts resulting from uncontrolled metal carbide-nitride deposition, can be reduced or prevented.

Additional phases may be added to the ALD cycle 30 as desired. The skilled artisan will appreciate that the principles disclosed here can be readily applied to depositing more complex materials by ALD. For example, an additional metal phase can be included to produce a film comprising two metal species. Thus, additional phases can be added to the cycle to produce a thin film with the desired composition. In other embodiments additional ALD cycles for depositing different materials can be utilized to produce more complex films.

Although referred to as the “first phase,” the “second phase” etc. . . . , these labels are for convenience and do not indicate the actual order of the phases in each ALD cycle unless indicated otherwise. Thus, the initial ALD cycle may be started with any of the phases described above. However, one of skill in the art will recognize that if the initial ALD cycle does not begin with the metal reactant phase, at least two ALD cycles will need to be completed to deposit about a monolayer of the desired thin film. A phase is considered to immediately follow another phase if only a purge or other reactant removal step intervenes.

Unreacted source chemicals and reaction by-products are preferably removed from the reaction space between pulses of reactants. This may be accomplished by purging with an inert gas and/or with the aid of a vacuum pump.

The ALD cycle 30 is preferably repeated until a thin film of the desired thickness is grown. Each ALD cycle may be identical in the deposition process. However, in some embodiments the nature of the ALD cycles may be varied.

If necessary, the exposed surfaces of a workpiece are terminated to react with the first phase of the ALD process prior to beginning the deposition process. The first phase of the preferred embodiment may be reactive, for example, with hydroxyl (OH) termination or termination left by an initial ammonia (NH₃) treatment. In some cases a separate termination step is not required. In some embodiments a fluorine termination is used.

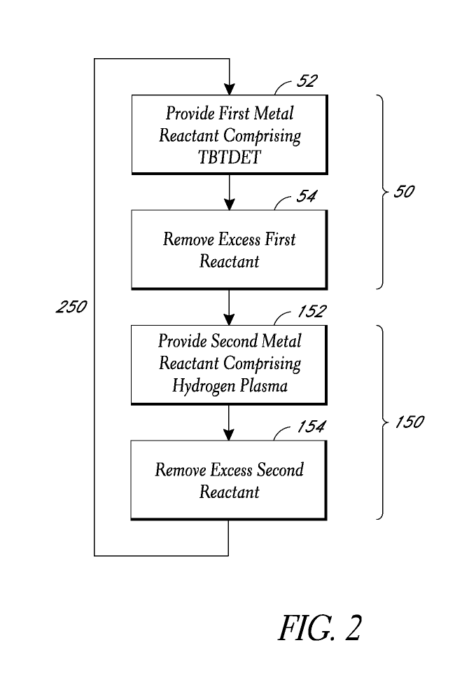

In another illustrated embodiment shown in FIG. 2, the first reactant is TBTDET, and the thin film being formed comprises TaCN. After initial surface termination, if necessary, a first reactant pulse 52 is supplied to the workpiece. In accordance with the preferred embodiment, the first reactant pulse 52 comprises a carrier gas flow and volatile TBTDET, which is reactive with the workpiece surfaces of interest. Accordingly, TBTDET adsorbs upon the workpiece surfaces.

Preferably the TBTDET is pulsed for about 0.1 second to about 10 seconds, more preferably about 0.1 second to about 1.0 second, still more preferably for about 0.2 second.

The TBTDET pulse 52 saturates the workpiece surfaces in a self-limiting manner such that any excess constituents of the pulse 52 do not further react with the monolayer formed by this process. Self-saturation results due to ligands terminating the monolayer, protecting the layer from further reaction.

The first TBTDET pulse 52 is preferably supplied in vapor form. The TBTDET is considered “volatile” for purposes of the present description if the species exhibits sufficient vapor pressure under the process conditions to transport the species to the workpiece in sufficient concentration to saturate exposed surfaces. Some reactants can be sufficiently volatile to saturate the substrate under deposition conditions despite being liquid or solid under standard (room temperature and atmospheric pressure) conditions.

After sufficient time for a monolayer of TBTDET to adsorb on the substrate surface, the first reactant is then removed 54 from the reaction space. Preferably, removal 54 merely entails stopping the flow of the first chemistry while continuing to flow a carrier gas for a sufficient time to diffuse or purge excess reactants and reactant by-products from the reaction space, typically with the aid of a vacuum pump. Preferably the removal 54 or purge comprises continuing to flow purge gas for between about 0.1 seconds and 20 seconds after stopping the flow of the first reactant pulse. Together, the adsorption pulse 52 and reactant removal 54 represent the first phase 50 in the ALD cycle 250.

In the illustrated embodiment, a second reactant pulse 152 comprising hydrogen plasma is then supplied to the workpiece. The hydrogen plasma desirably reacts with the monolayer of TBTDET left by the first reactant.

After a time period sufficient to completely saturate and react the monolayer with the second reactant pulse 152, any excess second reactant is removed 154 from the workpiece. As with the removal 54 of the first reactant, this removal 154 preferably comprises stopping the flow of the second chemistry and continuing to flow carrier gas for a time period sufficient for excess reactants and volatile reaction by-products from the second reactant pulse to diffuse out of and be purged from the reaction space. In some embodiments stopping the flow of the second chemistry comprises shutting off the plasma power. Together, the second reactant pulse 152 and removal 154 represent the second phase 150 in the illustrated process, and can also be considered the reduction phase, since the organometallic tantalum precursor is reduced to TaCN.

The two phases 50, 150 thus together represent one ALD cycle 250, which is repeated to form TaCN monolayers. While in the illustrated embodiment the ALD cycle begins with the metal phase, it is contemplated that in other embodiments the cycle may begin with the reduction phase.

One of skill in the art will recognize that in the described two-phase cycle, the first reactant phase 50 generally reacts with the termination left by the second phase 150 in the previous cycle. Thus, while no reactant may be previously adsorbed on the substrate surface or present in the reaction space if the reduction phase is the first phase in the first ALD cycle, in subsequent cycles the reduction phase will effectively follow the metal phase.

The ALD cycle 250 is repeated a number of times to produce a film sufficiently thick to perform its desired function.

In still in other arrangements, additional chemistries can also be included in each cycle or in various select cycles throughout the deposition process. For example, if necessary, the cycle 250 can be extended to include a distinct surface preparation. Moreover, one or more additional phases can be conducted in each cycle. For example, phases may be included that add additional components to the growing thin film.

The conditions in the reaction space are preferably arranged to minimize gas-phase reactions that can lead to the formation of condensed material. Thus, reactant chemical pathways are preferably kept separate until entering the reaction space. Reactions between species chemisorbed on the surface and a gaseous reactant self-saturate.

The deposition can be carried out at a wide range of pressure conditions, but it is preferred to operate the process at reduced pressure. The pressure in the reactor is preferably maintained from about 0.5 to 5 torr, more preferably from about 1 to 2 Torr, and even more preferably about 1.5 Torr.

The substrate temperature is kept low enough to keep the bonds between thin film atoms below the surface intact and to prevent thermal decomposition of the gaseous source chemicals. On the other hand, the substrate temperature is kept high enough to provide activation energy for the surface reactions for a thermal ALD process, and high enough to prevent the physisorption of source materials and minimize condensation of gaseous reactants in the reaction space. Depending on the reactants, the temperature of the substrate is typically about 100° C. to about 750° C., preferably about 200° C. to about 400° C., more preferably about 300° C. In a particular embodiment, tantalum carbide-nitride is preferably deposited from TBTEDT and hydrogen plasma at a substrate temperature of about 300° C.

The temperature of the reactant vapors at their sources is preferably set below the substrate temperature. This is based on the fact that if the partial pressure of the source chemical vapor exceeds the condensation limit at the substrate temperature, controlled layer-by-layer growth of the thin film is compromised.

As the growth reactions are based on self-saturated surface reactions, there is no need for setting tight upper boundaries for pulse and purge times. The amount of time available for the pulsing cycle is limited mostly by the economic factors, such as desired throughput of the product from the reactor. Very thin film layers can be formed by relatively few pulsing cycles and in some cases this allows the use of low vapor pressure source materials with relatively long pulse times.

In some embodiments, the films can be annealed following deposition, preferably at a temperature of about 700° C. to about 2000° C., more preferably at a temperature between about 850° C. and 1050° C.

The as-deposited films preferably have a stoichiometry of TaCₓNᵢ₋ₓ, which is a solid solution of FCC TaC and FCC TaN (space group F3m3). The crystal phase may be determined by x-ray diffraction and the stoichiometry by RBS. Films typically contain about 5 at % to about 15 at % hydrogen, with an oxygen concentration of less than about 1 at %.

Pure cubic TaN has been difficult to deposit using conventional ALD and CVD processes because Ta₃N₅ is typically formed, which has undesirable electrical properties for many applications. In prior art processes the density of Ta₃N₅ deposited by thermal ALD processes is typically between about 8.2 and 9.5 g/cm³. In some embodiments, the as deposited films preferably do not contain appreciable amounts of Ta₃N₅, which has a high resistivity and undesirable workfunction for many applications.

In some embodiments, the amount of crystalline Ta₃N₅ in the deposited tantalum films is not detectable by x-ray diffraction. In some embodiments, amorphous Ta₃N₅ may be present in small amounts. In some embodiments, the as deposited films preferably do not contain appreciable amounts of Ta₃N₅, which has a high resistivity.

In some embodiments, the as deposited films preferably do not contain appreciable amounts of Ta₅N₆, which has a high resistivity.

In some embodiments the process conditions and plasma parameters can be selected to deposit films having desired properties. For example, the process conditions and plasma parameters can be selected to deposit films having a desired resistivity, workfunction, composition, lattice constant, density, etc.

In some embodiments, the as deposited films have a lattice constant that can be tuned from about 4.336 Å for cubic TaN to about 4.444 Å for cubic TaC. Cubic TaC can be deposited by selecting lower plasma parameters, for example, a shorter plasma on-time and/or lower intensity plasma. Cubic TaN can be deposited by selecting higher plasma parameters, for example, longer plasma on-time and/or higher intensity plasma. In some embodiments the lattice constant may be below the 4.336 Å constant for cubic TaN with incorporation of other materials, for example substitutional hydrogen.

In some embodiments, the as deposited films have a density that can be tuned from about 10 g/cm³ (TaN) to about 12.5 g/cm³ (TaC). Cubic TaC with a density of about 12.5 g/cm³ can be deposited by selecting lower plasma parameters, for example, a shorter plasma on-time and/or lower intensity plasma. Cubic TaN with a density of about 10 g/cm³ can be deposited by selecting higher plasma parameters, for example, longer plasma on-time and/or higher intensity plasma.

In some embodiments the resistivity of the as deposited films can be tuned from about 245 μΩcm to about 2700 μΩcm. TaC with a resistivity of about 245 μΩcm can be deposited by selecting lower plasma parameters, for example, a shorter plasma on-time and/or lower intensity plasma. TaN with a resistivity of about 2700 μΩcm can be deposited by selecting higher plasma parameters, for example, longer plasma on-time and/or higher intensity plasma.

In some embodiments, the reaction conditions and plasma parameters for forming the tantalum films can be selected to achieve a desired workfunction of the deposited thin film.

In some embodiments, the composition and material of the substrate can also affect the crystallinity of the as deposited films. For example, deposition on a crystalline substrate material such as silicon can result in a thin film with a higher crystallinity than a film deposited on an amorphous material. The substrate material and composition can also change the growth rate, resistivity, and film stoichiometry.

In some embodiments, metal precursors can be used that do not contain carbon or nitrogen, for example tantalum halides (e.g. TaCl₅, TaF₅).

### Selecting Reaction Conditions

As disclosed herein, the reaction conditions for forming the metal carbide films can be selected to achieve the desired workfunction of the deposited metal carbide thin film.

In some embodiments, two different metal carbide films are deposited using two different deposition cycles. Preferably, a first metal carbide film is deposited followed by deposition of a second metal carbide film. The first and second metal carbide films can be deposited in-situ, for example in the same reaction space without introducing air into the system. Preferably, the same precursors and reactants are used to deposit the metal carbide films. Preferably, the first and second metal carbide films have different compositions and properties. The reaction conditions for the first and second metal carbide films are selected to provide the desired work function. Additional thin films can also be deposited.

In one embodiment, the desired workfunctions for the first and second film are selected. Next, the process conditions for the given reaction system and precursors are selected to achieve the desired work functions. Process conditions to achieve particular work functions can be determined by depositing one or more test films. The workfunction of the test film can be measured. If the test film does not have the desired workfunction then one or more of the process conditions can be modified and another test film can be deposited. The process conditions can be estimated and selected based on the relationships between process conditions and plasma parameters described herein and the desired workfunction of the deposited film from conditions including: selecting RF power, duration of plasma, plasma frequency, or ratio of gas flow rates.

The test process can be repeated until the process conditions have been determined for depositing the first and second metal carbide films with desired workfunctions.

After the process conditions for the particular configuration of the reaction system and particular precursors has been determined, then the first and second metal carbide films can be deposited via the methods described herein.

For example, the first metal carbide film could be deposited by repeating deposition cycle 30 under the selected process conditions. In one embodiment a first metal carbide film can be deposited by alternatingly exposing a substrate to pulses of a transition metal precursor and a plasma-excited hydrogen species, the metal precursor selected from the group consisting of transition metal halides and transition metal organic compounds and reacting metal from the metal precursor with a carbon species to form a first metal carbide film on the substrate, wherein the plasma parameters are selected to produce a first metal carbide film with a desired workfunction.

Next, the process conditions can be changed for the second metal carbide deposition cycle. The deposition cycle 30 can then be repeated with the second set of process conditions to form a second metal carbide film with the desired properties. In one embodiment a second metal carbide film can be deposited by alternatingly exposing a substrate to pulses of a transition metal precursor and a plasma-excited hydrogen species, the metal precursor selected from the group consisting of transition metal halides and transition metal organic compounds and reacting metal from the metal precursor with a carbon species to form a second metal carbide film on the substrate, wherein the plasma parameters are selected to produce a second metal carbide film with a workfunction different from the first metal carbide film.

In some embodiments, the first cycle can be used to deposit a p-type or re-type metal thin film. In some embodiments, the second cycle can be used to deposit a p-type or n-type metal thin film.

In some embodiments, there are intervening process steps between the first deposition cycle and second deposition cycle.

In some embodiments, the p-type and n-type metal thin films are deposited in the same reactor using the same reactants.

In some embodiments, the first metal carbide thin film and the second metal carbide thin film are not continuous. In some embodiments, the first metal carbide thin film and the second metal carbide thin film are not in direct contact.

In some embodiments, the same reactants are preferably used to deposit the first and second metal carbide films. Preferably, the first and second metal carbide films have different workfunctions.

### Reaction System

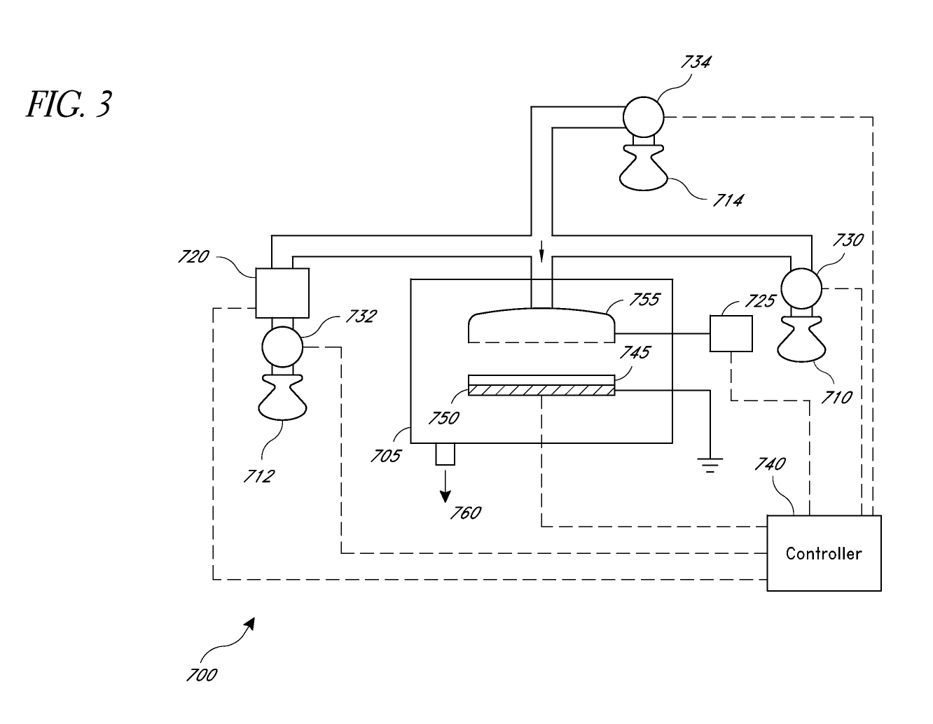

A reaction system 700 configured to form a metal carbide-nitride film over a substrate according to methods and processes of preferred embodiments is shown in FIG. 3. The reaction system 700 includes a reaction space 705, vapor (or gas) source vessels (“vessels”) 710 and 712, a remote plasma generator 720, a power supply 725 for in situ plasma generation, and valves 730 and 732 upstream of the vapor source vessels 710 and 712, respectively. While illustrated with both remote and in situ plasma sources, it will be understood that the reaction system 700 may be configured for either in situ or remote plasma generation. Remote plasma generators are readily available and may couple, e.g., microwave energy to a flowing gas. Plasma generators can couple various other forms of energy (e.g., ultraviolet, inductive, capacitive, etc) to a gas. The reaction space 705 is preferably configured for plasma-enhanced vapor deposition, more preferably plasma-enhanced atomic layer deposition (PEALD).

In the illustrated embodiment, vessel 710 is configured to provide a metal source chemical; vessel 712 is configured to provide one or more precursors (e.g., H₂, N₂, CH₄, etc.) for generating plasma-excited species. However, it will be appreciated that the vessels 710 and 712 can provide any species in accordance with preferred embodiments of the invention. Vessel 714 may optionally provide an additional reactant through valve 734 if a more complex film is to be deposited.

The reaction system 700 of the illustrated embodiment is configured to process a substrate 745. The substrate 745 is supported atop a substrate support platform 750, which may be a heated chuck or a susceptor. The illustrated reaction space 705 also comprises a showerhead 755 for uniformly distributing reactants across a top surface of the substrate 745, although other arrangements, such as, e.g., horizontal laminar flow arrangements, are also possible. In cases where in situ plasma generation is desired, the showerhead 755 may also serve as one electrode of the in situ plasma generator and the combination of the substrate 745 and the substrate support platform 750 may serve as the other electrode. In the illustrated embodiment, the showerhead 755 serves as the positive electrode and the combination of the substrate 745 and the substrate support platform 750 (which are grounded) serves as the negative electrode. A showerhead configured for plasma-enhanced atomic layer deposition is described in U.S. Patent Publication No. 2004/0231799, the disclosure of the showerhead is incorporated herein by reference.

The reaction system 700 further comprises a controller 740 configured to control various aspects of wafer processing, such as pulsing of a metal source chemical, a plasma-excited species and a source chemical of a species desired in a metallic-compound film; wafer temperature; reaction space pressure; reactant(s) and reaction by-product(s) removal; and plasma generation. Preferably, the controller 740 is also configured to control plasma generation parameters, which include, without limitation, radio frequency (RF) power on time, RF power amplitude, RF power frequency, reactant concentration, reactant flow rate, reaction space pressure, total gas flow rate, reactant pulse durations and separations, and RF electrode spacing. It would be appreciated that the controller 740 is configured to control different plasma parameters for various types of plasma generators. Depending on the type of plasma generator (i.e., in situ or remote), different plasma parameters may be controlled by the controller 740. Additionally, the controller is configured to control various vapor source temperatures external to the reaction space 705. The controller 740 may comprise one or more computers configured to communicate with each other and various processing units of the reaction system 700. In the illustrated embodiment, the controller 740 is in communication (dotted lines) with the remote plasma generator 720, in situ plasma generator 725, valves 730, 732 and 734, and one or more heaters and thermocouples (not shown) in the substrate support platform 750. The controller 740 is also configured to control robot movement for loading and unloading a substrate(s) to and from the reaction space 705. The controller 740 is configured to open and close valves 730, 732 and 734. The controller is also configured to control reactant and by-product removal from the reaction space 705 through exit passage 760. Reactant and by-product removal may comprise purging the reaction space 705 with a purge gas and/or pumping with the aid of a pumping system (now shown). Purge gas may be supplied through one of the vapor source vessels 710, 712 and 714, or other passages (not shown) in fluid communication with the reaction space 705. If a source chemical (e.g., metal source chemical, source chemical of a species desired in a metallic-compound film) is pulsed with a carrier gas (e.g., H₂, Ar), the carrier gas may serve as the purge gas, and the controller 740 is configured to control the degree of mixing of the source chemical and the carrier gas. In some embodiments, the controller 740 is configured to control a pumping system (not shown).

For in situ plasma generation, gas (or a plurality of gases) is directed from at least one of the vapor source vessels 712, 714 though gas flow passages to the showerhead 755 within the reaction space 705. Application of RF power from the power supply 725 to the showerhead generates plasma-excited species of a gas (or a plurality of gases). The gas is subsequently directed to the top surface of the substrate 745 through openings in the showerhead 755. The controller 740 controls plasma parameters to form a metallic-compound film of predetermined composition as described with respect to the methods above. For remote plasma generation, gas is directed from the vapor source vessel 712 to the remote plasma generator, where plasma-excited species are generated and subsequently directed through gas flow passages to the reaction space 705.

In one embodiment, the controller 740 is programmed to carry out two distinct metal carbide ALD deposition cycles. The first cycle comprises exposing a substrate to metal and carbon-containing reactants to deposit a first film comprising the metal and carbon; exposing the first film comprising metal and carbon to a plasma-excited hydrogen species to form a first metal carbide film having a first composition with a desired work function. The controller is programmed to repeat the first cycle until a film with a desired thickness is formed. The second cycle comprises forming a second film comprising metal and carbon by exposing a substrate to metal and carbon-containing reactants; and exposing the second film comprising metal and carbon to a plasma-excited hydrogen species to form a second metal carbide film having a second composition with a different work function. The controller is programmed to repeat the second cycle until a film with a desired thickness is formed.

It will be appreciated that modifications of the reaction system 700 are possible without departing from the scope of the invention. For example, although a showerhead 755 is shown in the reaction space 705, it will be appreciated that the reaction space 705 may include any structure or apparatus for distributing vapor over the substrate 745. As another example, the reaction system 700 may include more than two gas flow passages for directing vapor into the reaction space 705. As yet another example, the reaction space 705 may be configured to process a plurality of substrates. As yet another example, the reaction system 700 may include any number and configuration of vapor source vessels and valves. For instance, the reaction system 700 may include five source vessels in communication with the reaction space 705. As yet another example, although the reaction space 705, as illustrated, is configured to accommodate a single wafer 745, it will be appreciated that the reaction space 705 may be a batch reactor configured to process multiple wafers at a time.

Preferably, the system 700, particularly the controller 740, is programmed or otherwise configured to conduct the processes described herein, employing tailored plasma parameters to achieve tailored composition of metallic-compound films (e.g., to control the work function of a transistor gate electrode).

In at least some of the aforesaid embodiments, any element used in an embodiment can interchangeably be used in another embodiment unless such a replacement is not feasible.

### Example 1

Various tantalum carbide-nitride film deposition runs were performed in the EmerALD 3000™ plasma enhanced atomic layer deposition PEALD Process Module of a Polygon® 8200, 8300, available from ASM International N.V. of Bilthoven, The Netherlands. In each run, the tantalum carbide-nitride film was deposited on a silicon dioxide (SiO₂) surface of a substrate.

The sequence of steps included alternately and sequentially pulsing a TBTDET and plasma-excited hydrogen gas into the reaction chamber accommodating the substrate. The deposition was conducted at substrate temperatures ranging from about 200° C. to about 400° C., with most of the reactions at a temperature of about 300° C. Pressure ranged from about 1 to about 2 Ton, with the majority of the experiments at about 1.5 Torr.

A mixture of argon and hydrogen gas (typically 60% H₂ and 40% Ar) was used as the carrier gas for the TBTDET and as the hydrogen plasma source gas. The flow rate of the carrier gas was held at approximately 300 sccm. Plasma-excited hydrogen species were generated in the carrier gas by supplying power to parallel-plates to form capacitively coupled plasma (CCP), varying from about 125 W to about 400 W to a showerhead disposed over the substrate. The sequence of gas pulses and pulsing times (seconds, “s”) were as follows:

(1) TBTDET pulse (2-4 s);

(2) Ar purge (2-4 s);

(3) Plasma on time pulse (1-5 s);

(4) Ar purge (0-5 s);

Steps (1)-(4) were repeated approximately 550-600 times to form a tantalum carbide film with thickness of about 200 Å. The film growth rate was about 0.35 Å/cycle.

Plasma power was varied between 50 W and 400 W. Generally, the higher the plasma power the greater the nitrogen content in the deposited film. Typically, the resistivity of the deposited film decreased with increased plasma on time.

Plasma on time was varied from 1 second to about 5 seconds. Generally, the longer the plasma on time the greater the nitrogen content in the deposited film. Typically, the resistivity of the deposited film decreased with increased plasma on time.

The deposition temperature was varied between about 275° C. and 375° C. The reactor pressure was around 1.5 or 2 Torr for the experiments.

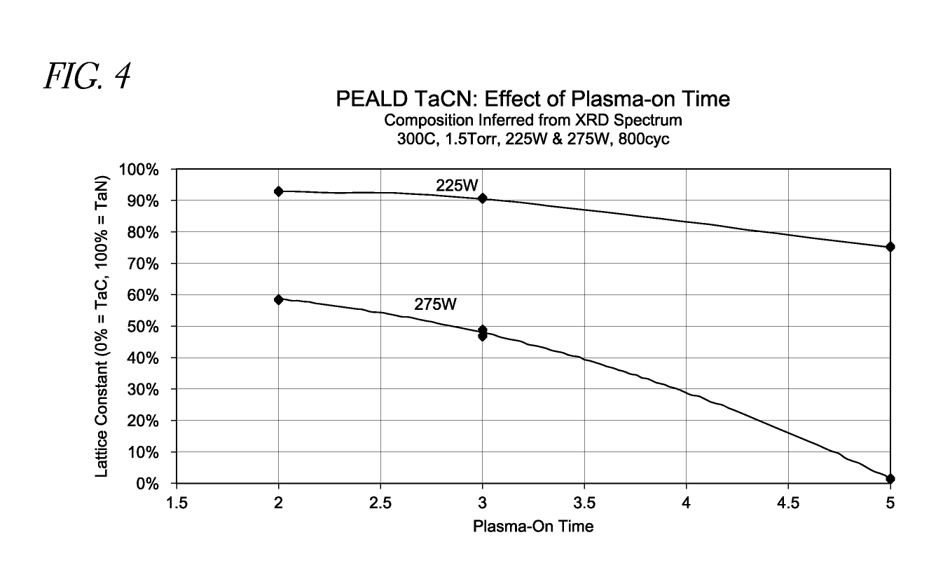

FIGS. 4-6 illustrate data for films formed at deposition temperature of about 300° C., a reactor pressure of 1.5 Torr, and about 800 cycles. TBTDET was used as a precursor with hydrogen plasma. The plasma power and on time were varied.

FIG. 4 is a graph illustrating the lattice constant versus plasma on-time for TaCN thin films deposited in accordance with various embodiments with a plasma power of 225 W and 275 W. FIG. 4 shows that the carbon content of the deposited TaCN film increased with increasing plasma on time and also with increased plasma strength. The use of 275 W plasma resulted in the deposition of a more carbon rich film than with the use of 225 W plasma for the same plasma on-time and with other reaction variables constant.

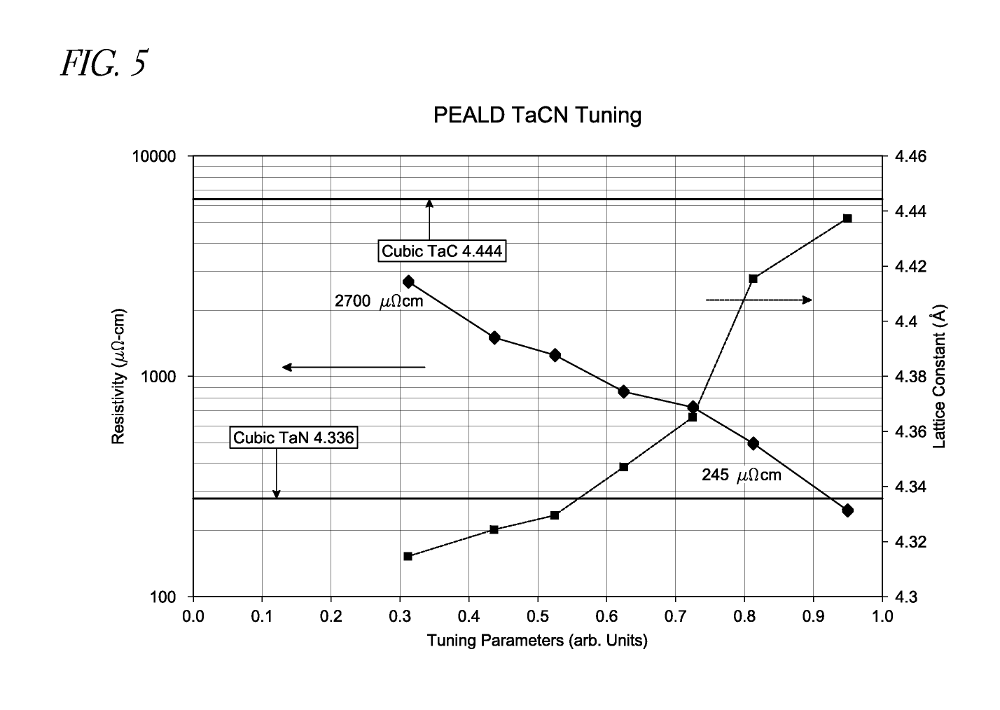

FIG. 5 is a graph illustrating the lattice constant and resistivity versus plasma tuning for TaCN thin films deposited in accordance with various embodiments. As the plasma tuning parameter was increased the lattice constant increased, which indicated that the deposited film was more carbon rich. As illustrated in FIG. 5, cubic TaN has a lattice constant of around 4.336 Å and cubic TaC has a lattice constant around 4.444 Å. The resistivity of the deposited films also changed with increased plasma tuning parameter. The resistivity of the deposited films varied from 245 μΩcm to about 2700 μΩcm. A resistivity of 2700 μΩcm was achieved with a lower plasma tuning parameter, which deposited a TaN film or a nitrogen rich TaCN film. A resistivity of 245 μΩcm was achieved with a higher plasma tuning parameter, which deposited a TaC film or a carbon rich TaCN film.

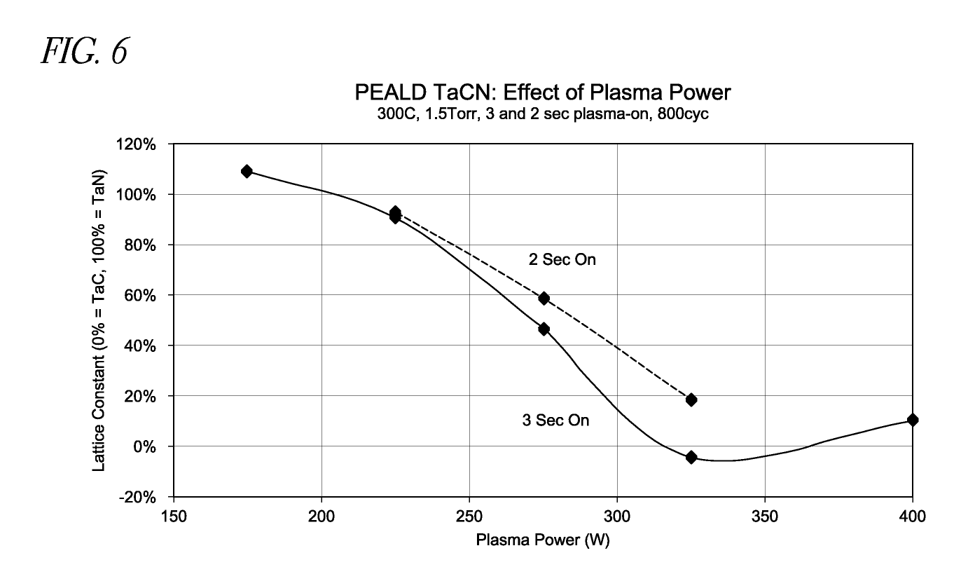

FIG. 6 is a graph illustrating the lattice constant versus plasma power for TaCN thin films deposited in accordance with various embodiments. FIG. 6 shows that the carbon content of the deposited TaCN film increased with increasing plasma power. FIG. 6 shows that the carbon content of the deposited TaCN was greater with a longer plasma on-time.

It will be understood by those skilled in the art that, although this invention has been disclosed in the context of certain embodiments and examples, the present invention extends beyond the specifically disclosed embodiments to other alternative embodiments and/or uses of the invention and obvious modifications and equivalents thereof. It is also contemplated that various combinations or sub-combinations of the specific features and aspects of the embodiments may be made and still fall within the scope of the invention. Accordingly, it is intended that the scope of the present invention disclosed herein should not be limited by the particular disclosed embodiments described above, but should be determined by the claims that follow.

We claim:

1. A method of forming an integrated circuit comprising:
a first deposition cycle depositing a first metal carbide film comprising:
alternatingly exposing a substrate to pulses of a transition metal precursor and a plasma-excited hydrogen species, the metal precursor selected from the group consisting of transition metal halides and transition metal organic compounds; and
reacting metal from the metal precursor with a carbon species to form the first metal carbide film on the substrate, wherein a first plasma parameter is selected to produce a first metal carbide film with a first composition; and
a second deposition cycle depositing a second metal carbide film, wherein the precursors in the second deposition cycle are the same as the precursors in the first deposition cycle, wherein a second plasma parameter is selected in the second deposition cycle that is different from the first plasma parameter and is selected to produce a second metal carbide film with a composition different from the first metal carbide film.

2. The method of claim 1, wherein the second deposition cycle comprises:
alternatingly exposing a substrate to pulses of a transition metal precursor and a plasma-excited hydrogen species, the metal precursor selected from the group consisting of transition metal halides and transition metal organic compounds; and
reacting metal from the metal precursor with a carbon species to form a second metal carbide film on the substrate,

3. The method of claim 1, wherein the plasma parameters are selected to produce a second carbide metal film with a workfunction different from the first metal carbide film.

4. The method of claim 2, wherein the metal halide is TaF₅ or TaCl₅.

5. The method of claim 2, further comprising exposing the substrate to a pulse of a hydrocarbon between each metal precursor pulse and plasma-excited species pulse.

6. The method of claim 5, wherein the hydrocarbon is selected from the group consisting of alkanes, alkenes and alkynes.

7. The method of claim 1, wherein the carbon species is derived from the metal precursor.

8. The method of claim 7, wherein the metal precursor is a metal organic compound, and wherein reacting the metal comprises reacting a carbon-containing ligand of the metal with the metal.

9. The method of claim 8, wherein the carbon-containing ligand is an alkyl group.

10. The method of claim 8, wherein the metal precursor comprises a plurality of carbon-containing ligands.

11. The method of claim 1, wherein metal precursor is tertbutylimide-tridiethylamide-tantalum (TBTDET).

12. The method of claim 1, wherein exposing the substrate to pulses of the plasma-excited hydrogen species comprises exposing the substrate to plasma-excited argon and hydrogen species.

13. The method of claim 1, wherein exposing the substrate to the metal precursor self-limitingly deposits a layer of the metal on the substrate, wherein reacting metal from the metal precursor with the carbon species comprises reacting the layer of the metal after depositing the layer of the metal.

14. The method of claim 1, wherein the first and second metal carbide films comprise TaCN films with different compositions.

15. The method of claim 1, wherein the first and second metal carbide films are deposited in the same reaction chamber.

16. A method for forming an integrated circuit comprising:
exposing a substrate to metal and carbon-containing reactants to deposit a first film comprising the metal and carbon;
exposing the first film comprising metal and carbon to a plasma-excited hydrogen species to form a first metal carbide film having a first composition;
forming a second film comprising metal and carbon by exposing a substrate to metal and carbon-containing reactants; and
exposing the second film comprising metal and carbon to a plasma-excited hydrogen species to form a second metal carbide film having a second composition, wherein the second composition is different from the first composition, wherein the same reactants are used to form the first and second films.

17. The method of claim 16, wherein the first and second metal carbide films have a desired workfunction.

18. The method of claim 16, wherein the plasma parameters comprise: plasma power and plasma pulse duration.

19. The method of claim 16, wherein exposing the substrate and exposing the film to form the first metal carbide film steps are repeated until the first film has a desired thickness.

20. The method of claim 16, wherein the first and second films are not continuous.

21. The method of claim 16, wherein the first and second films are formed in the same reactor.

22. The method of claim 16, wherein exposing the substrate to metal and carbon-containing reactants comprises exposing the substrate to a single precursor containing the metal and carbon.

23. The method of claim 16, wherein forming the first film comprises alternatingly exposing the substrate to a pulse of a metal precursor and a pulse of plasma-excited hydrogen species.

24. The method of claim 16, wherein sequentially exposing the substrate to one pulse of the metal precursor and one pulse of plasma-excited hydrogen species constitute a metal deposition cycle, wherein exposing the substrate to metal and carbon-containing reactants and exposing the film constitute a metal/carbon cycle, further comprising performing a plurality of consecutive metal cycles followed by a plurality of consecutive metal/carbon cycles.

25. The method of claim 24, further comprising sequentially repeating performing the plurality of consecutive metal cycles followed by the plurality of consecutive metal/carbon cycles to form a nanolaminate film.

26. The method of claim 16, wherein exposing the film to the plasma-excited hydrogen species comprises exposing the film to plasma-excited argon and hydrogen species.

27. The method of claim 16, wherein exposing the substrate to metal and carbon-containing reactants comprises exposing the substrate to a transition metal precursor.

28. The method of claim 27, wherein the transition metal is selected from the group consisting of titanium (Ti), zirconium (Zr), hafnium (Hf), vanadium (V), niobium (Nb).

29. The method of claim 28, wherein the transition metal is tantalum (Ta).

30. The method of claim 16, wherein exposing the substrate to metal and carbon-containing reactants is performed below a decomposition temperature of the metal and carbon-containing reactants.

31. The method of claim 16, wherein exposing the substrate to metal and carbon-containing reactants is performed at a deposition temperature of about 150° C. to about 550° C.

32. The method of claim 16, wherein the plasma-excited hydrogen species is formed within a reaction chamber accommodating the substrate.

33. The method of claim 16, wherein exposing the substrate to metal and carbon-containing reactants comprises depositing about a monolayer of a compound comprising the metal.

34. The method of claim 16, wherein forming the metal carbide film forms an electrode for an electronic device.

35. The method of claim 34, wherein forming the metal carbide forms an electrode for a transistor.

36. A system for depositing metal carbide films, comprising:
a reaction chamber;
a plasma generator;
a metal precursor source in gas communication with the reaction chamber;
a carbon precursor source in gas communication with the reaction chamber;
a hydrogen source in gas communication with the reaction chamber; and
a controller programmed to perform a first metal carbide cycle comprising providing a plurality of pulses of the metal precursor and the carbon precursor to the reaction chamber and to separately provide pulses of a hydrogen plasma into the reaction chamber between the pulses of the metal precursor and the carbon precursor; and the controller further programmed to perform a second metal carbide cycle comprising alternately provide pulses of additional metal precursor and pulses of hydrogen plasma to the reaction chamber in a cycle with the plurality of pulses of the metal precursor and the carbon precursor and the separately provided pulses of hydrogen plasma.

37. The system of claim 36, wherein the controller is programmed to provide a continuous flow of hydrogen into the reaction chamber, wherein the controller is further programmed to pulse plasma power in the plasma generator to generate the pulses of hydrogen plasma.

38. The system of claim 36, wherein the controller is further programmed to provide hydrogen plasma under conditions to deposit a first metal carbide film with a desired workfunction.

39. The system of claim 38, wherein the controller is further programmed to provide hydrogen plasma under conditions to deposit a second metal carbide film with a desired workfunction different than the first metal carbide film.

40. The system of claim 36, further comprising an argon source in gas communication with the reaction chamber, wherein the controller is programmed to provide pulses of argon simultaneously with the pulses of hydrogen plasma.

41. The system of claim 36, wherein the metal precursor source comprises a transition metal.

42. The system of claim 41, wherein the transition metal is selected from the group consisting of titanium (Ti), zirconium (Zr), hafnium (Hf), vanadium (V), niobium (Nb), and tantalum (Ta).
